(19) United States
(12) Patent Application Publication
(10) Pub. No.: US 2009/0276401 A1
(43) Pub. Date: Nov. 5, 2009

(54) METHOD AND APPARATUS FOR MANAGING ASSOCIATIVE PERSONAL INFORMATION ON A MOBILE COMMUNICATION DEVICE

(75) Inventors: Michael E. GROBLE, Lake Zurich, IL (US); Andrew W. Davidson, Chicago, IL (US); Jorge G. Kirch, Schaumburg, IL (US); Hiren M. Mandalia, Schaumburg, IL (US)

Correspondence Address: PRASS LLP, 2661 Riva Road, Bldg. 1000, Suite 1044, ANNAPOLIS, MD, 21401, US

(73) Assignee: Motorola, Inc., Schaumburg, IL (US)

(21) Appl. No.: 12/114,447

(22) Filed: May 2, 2008

(51) Int. Cl. G06F 17/30; G06F 7/06

(52) U.S. Cl. 707/3; 707/E17.009; 707/E17.014; 707/E17.032

(57) ABSTRACT

A method and apparatus that manages associative personal information may include determining associative properties, receiving an item to be associated to the determined associative properties, indexing the received item based on the determined associative properties, storing the received item and the associated indexing information, receiving at least one of a query from a user and information concerning the user's navigation of one or more interfaces on the mobile communication device, matching at least one of the user's query and the user's navigation information to the associative properties, checking the associated indexing information for stored items associated to the matched associated properties, generating a list of stored items associated to the matched associated properties based on the associated indexing information, presenting the generated list of stored items associated to the matched associated properties to the user, and receiving the user's selection of one or more stored item from the generated list.

### BACKGROUND OF THE DISCLOSURE

1. Field of the Disclosure

The disclosure relates to mobile communication devices and in particular, to managing associative personal information on mobile communication devices.

2. Introduction

Mobile communication device users often have large electronic stores of personal information that they find increasingly difficult to fully utilize. When tens of thousands of items are created and stored on a mobile communication device, a user can find it extremely cumbersome to navigate through menus and user interfaces to retrieve desired information.

In addition, the metaphors for dealing with vast amounts of data on the internet do not apply well to personal information. Keyword-based search is the norm for internet data and has been applied to personal information. But within the context of mobile devices, this technique is not adequate. First, keyword entry is difficult and second, a person does not have the capacity to remember the titles or keywords associated with tens of thousands of items. For example, if an individual downloaded a couple of albums, he or she may only know the names of all but one or two of the songs. Furthermore, while they may remember the artist's name, they may not remember the album names.

With a mobile communication device, most activities are situated in some real-world context. While the brain is not good at remembering 10,000 item titles, it is very good at remembering things by association. For example, the user may not remember the titles, but he or she knows they downloaded them (they were added to the device) on a certain day. In another example, he or she may know they met someone at a conference last month and read in their business card to the device. While they remember the conference name and the time of the conference, he or she may not remember the person's name or their company's name. Thus, existing internet search metaphors completely break down in these cases.

### SUMMARY OF THE DISCLOSURE

A method and apparatus that manages associative personal information on a mobile communication device is disclosed. The method may include determining one or more associative properties, receiving an item to be associated to the one or more determined associative properties, indexing the received item based on the one or more determined associative properties, storing the received item and the associated indexing information, receiving at least one of a query from a user and information concerning the user's navigation of one or more interfaces on the mobile communication device, matching the at least one of the query from the user and information concerning the user's navigation of one or more interfaces on the mobile communication device to one or more associative properties, checking the associated indexing information for stored items associated to the matched one or more associated properties, generating a list of stored items associated to the matched one or more associated properties based on the associated indexing information, presenting the generated list of stored items associated to the matched one or more associated properties to the user, receiving the user's selection of one or more stored item from the generated list, and presenting the selected item to the user.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 illustrates an exemplary diagram of a mobile communication device in accordance with a possible embodiment of the disclosure;

FIG. 2 illustrates a block diagram of an exemplary mobile communication device in accordance with a possible embodiment of the disclosure;

FIG. 3 is an exemplary flowchart illustrating one possible associative personal information management process in accordance with one possible embodiment of the disclosure;

FIG. 4 is a screen shot of an exemplary associative personal information management interface in accordance with a possible embodiment of the disclosure; and

FIG. 5 is another screen shot of an exemplary associative personal information management interface in accordance with a possible embodiment of the disclosure.

### DETAILED DESCRIPTION OF THE DISCLOSURE

Additional features and advantages of the disclosure will be set forth in the description which follows, and in part will be obvious from the description, or may be learned by practice of the disclosure. The features and advantages of the disclosure may be realized and obtained by means of the instruments and combinations particularly pointed out in the appended claims. These and other features of the present disclosure will become more fully apparent from the following description and appended claims, or may be learned by the practice of the disclosure as set forth herein.

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

The disclosure comprises a variety of embodiments, such as a method and apparatus and other embodiments that relate to the basic concepts of the disclosure.

This disclosure may concern indexing resources on a mobile communication device to enable associative retrieval of them. In general, this process may allow users easy access to the growing body of personal information they are able to collect and access electronically. In particular, the disclosure may concern:
An indexing mechanism which tracks users' content creation, acquisition and usage behaviors so resources can be accessed later by association to other resources.
Automatic creation of user interface aggregation and navigation mechanisms to allow easy exploration/retrieval of associations by the user.
Context dependent definition of association relevance including based on resource type, association type and scale of association similarity.

Each resource may be indexed with two types of information, a creation index and an access index, as shown in the table below:

| | |
|---|---|
| Identifier | A unique identifier (for example a URI) |
| | that the interaction agent is able to |
| | interpret |
| Type | A type indicator, similar to mime types, |
| | which are used to indicate what type of |
| | resource. Resources types consists of |
| | things that would be stored or accessible |
| | from the device such as: contact entry, |
| | song, ringtone, document, video clip, |
| | podcast, photo, calendar event, message |
| Sender | Reference to a contact entry identifier of |
| | the person who sent the material. For |
| | example, an photo attached to an e-mail. |
| Creation time | Time the resource was created, received |
| | or imported by the user. |
| Creation | Location of the user when the resource |
| location | was created, received or imported by the |
| | user. |
| Time span | For resources representing a span of time |
| | (such as calendar events), the time-span |
| | of the resource. |
| Title | The title of the resource |
| Tags | Tags or annotations attached to the |
| | resource by the user |

Each resource may also have an access/modification log associated with it with index values indicating Access time, Access location, Access count/rate, Receiver, etc., for example. Once accessed or modified at certain rate or number of times, the association process may choose to “forget” the resource or de-prioritize it based on the evidence that the user is familiar with it (from frequent access) and does not need cognitive assistance to find it.

A receiver index may be used to track elements sent by the user to others. This may be a reference to a contact entry identifier of the person to whom the resource was sent, for example.

Records may be judged to be associated based on proximity or similarity of the index information. These similarity measures may be derived from predicates which have a continuous normalized truth value in the range [0,1]. The predicates may include the following:

| | |
|---|---|
| Created during | True for resources which have a |
| | Creation time during the Time span of |
| | the resource of interest |
| Created near in time | True for resources which have a |
| | Creation time in proximity to the |
| | Creation time of the resource of |
| | interest |
| Created near in space | True for resources which have a |
| | Creation location in proximity to the |
| | Creation location of the resource of |
| | interest |
| Duration encloses | True for resources which have a Time |
| creation of | span which encloses the Creation time |
| | of the resource of interest |
| Sent to | True for resources which have an |
| | access entry with the Receiver |
| | matching the identifier of the resource |
| | of interest |
| Received from | True for resources which have a |
| | Sender matching the identifier of the |
| | resource of interest |
| Title contains similar | True for resources which have a Title |
| | containing text similar to the Title of |
| | the resource of interest |
| Has similar tag | True for resources which have Tags |
| | containing text similar to the Tags of |
| | the resource of interest |
| Accessed during | True for resources which have an |
| | Access time during the Time span of |
| | the resource of interest |
| Accessed near in time | True for resources which have an |
| | Access time in proximity to the |
| | Creation or Access time of the |
| | resource of interest |
| Accessed near in space | True for resources which have an |
| | Access location in proximity to the |
| | Creation or Access location of the |
| | resource of interest |
| Duration encloses access | True for resources which have a Time |
| of | span which encloses the Access time |
| | of the resource of interest |

Note that the above terms are described in Boolean terms (“True for resources . . . ”), but the similarity scores may be continuous. The “Created during” case may assign a value of 1 to those items within the Time span, but need not assign a value of 0 to those outside the Time span. In general, times further from the Time span may get lower scores, but this need not be a linear or even concave relationship. It suffices that it be non-decreasing, for example.

An association query may include a mandatory set of anchor resources a desired limit to the number of returned associated items and three optional parameters. The anchor set may include identifiers which are of interest to the user. They may also support arbitrary queries through the use of pseudo-identifiers. For example, a time pseudo-identifier may look like “create_time:/20070907T110000Z”. In case the user is looking for photos taken during some event that is in their calendar, navigating to that event may cause the interaction agent to request associations based on the identifier of the event, e.g. “http://www.google.com/calendar/event?eid=XYZ . . . ”. But in some cases, an event may not exist. When the user navigates to a specific day in the calendar, the agent may send a pseudo-identifier representing that day (e.g. “create_time:/20070907”) to retrieve associated items without having a specific resource indexed for that day. These pseudo-identifiers can be used for any of the index parameters.

The optional parameters allow the agent to customize the ranking algorithm used to retrieve resulting associations. One is weighting of resource types. If the agent knows the user is searching for photographs, it may request photos exclusively. If the agent is maintaining a probabilistic belief state over a number of different categories, it may provide that weighting to modify the ranking criteria. Another optional parameter may be a weighting of predicates to control whether certain predicates are more important than others in the results (for example, creation time vs. access time or time vs. location).

Finally, the agent may provide a predicate scope indication to control how widely to consider similarity. Again, the agent may know how precise or vague the user may be about the association. From the example above, if the user is looking at a calendar event and the event is only an hour long, the agent may infer to only search for items within a narrow time range of that. On the other hand, if the user is just looking at a day on the calendar, the agent may specify a wider time range, or a more lax interpretation of similarity. This may be done on a per-predicate basis, or on a per-dimension basis (e.g. one measure for all times, a different measure for all spatial distances, a different measure for all textual differences).

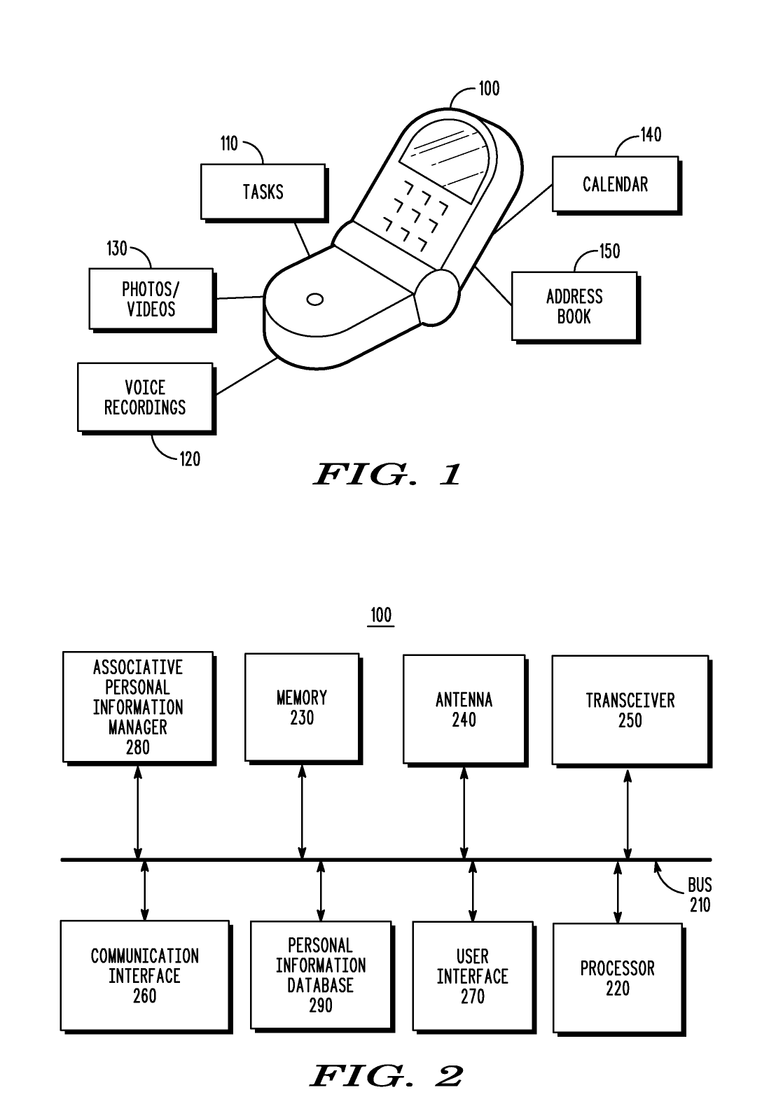

FIG. 1 illustrates an exemplary diagram of a mobile communication device 100 in accordance with a possible embodiment of the disclosure. The mobile communication device 100 may have several items of personal information stored thereon, including one or more of the following: tasks 110, voice recordings 120, photos/videos 130, calendar 140, and address book 150.

Tasks 110 may be a list or action or to-do items that may have been assigned at a particular event, time, or location, for example. Voice recordings 120 may be voice mails, voice notes, or voice recordings made or created at a particular event, time, or location, for example. Photos/videos 130 may be photos or video clips that may have been made or created at a particular event, time, or location, for example. Calendar 140 may include events that may include time, date, event, speaker, contacts, location, etc. information. Address book 150 may include contact information for individuals that were previously entered or made or created at a particular event, time, or location, for example. The address book 150 may include address, name, phone number, e-mail, company, or other information. Note that while several personal items are shown in FIG. 1, these are not intended to be limiting and there may be many other personal items stored on the mobile communication device 100.

The mobile communication device 100 may be a portable MP3 player, satellite radio receiver, AM/FM radio receiver, satellite television, portable music player, portable computer, wireless radio, wireless telephone, portable digital video recorder, cellular telephone, mobile telephone, personal digital assistant (PDA), or combinations of the above, for example.

FIG. 2 illustrates a block diagram of an exemplary mobile communication device 100 in accordance with a possible embodiment of the invention. The mobile communication device 100 may include a bus 210, a processor 220, a memory 230, an antenna 240, a transceiver 250, a communication interface 260, a user interface 270, an associative personal information manager 280, and a personal information database 290. Bus 210 may permit communication among the components of the mobile communication device 100.

Processor 220 may include at least one conventional processor or microprocessor that interprets and executes instructions. Memory 230 may be a random access memory (RAM) or another type of dynamic storage device that stores information and instructions for execution by processor 220. Memory 230 may also include a read-only memory (ROM) which may include a conventional ROM device or another type of static storage device that stores static information and instructions for processor 220.

Transceiver 250 may include one or more transmitters and receivers. The transceiver 250 may include sufficient functionality to interface with any network or communications station and may be defined by hardware or software in any manner known to one of skill in the art. The processor 220 is cooperatively operable with the transceiver 250 to support operations within one or more communications network. The transceiver 250 transmits and receives transmissions via one or more of the antennae 240 in a manner known to those of skill in the art.

Communication interface 260 may include any mechanism that facilitates communication via one or more communications network. For example, communication interface 260 may include a modem. Alternatively, communication interface 260 may include other mechanisms for assisting the transceiver 250 in communicating with other devices and/or systems via wireless connections.

User interface 270 may include one or more conventional input mechanisms that permit a user to input information, communicate with the mobile communication device 100, and/or present information to the user, such as a an electronic display, microphone, touchpad, keypad, keyboard, mouse, pen, stylus, voice recognition device, buttons, one or more speakers, etc.

Personal information database 290 is a database of personal information of one or more mobile communication device user. For example, the personal information may be partitioned into two users' files, such as “Matthew's personal information” and “Megan's personal information.” The personal information may include calendars, voice recordings, photos, contacts, address book, etc. that have been stored on the mobile communication device 100. This personal information may be called up by the associative personal information manager 280, as discussed further below. The personal information database 290 may stored in memory 230 or stored separately on the mobile communication device 100 or on a storage card attached to the mobile communication device 100.

The mobile communication device 100 may perform such functions in response to processor 220 and/or associative personal information manager 280 by executing sequences of instructions contained in a computer-readable medium, such as, for example, memory 230. Such instructions may be read into memory 230 from another computer-readable medium, such as a storage device or from a separate device via communication interface 260.

For illustrative purposes, the functions of the associative personal information manager 280 and the information storage process will be described below in relation to the diagrams shown in FIGS. 1-2.

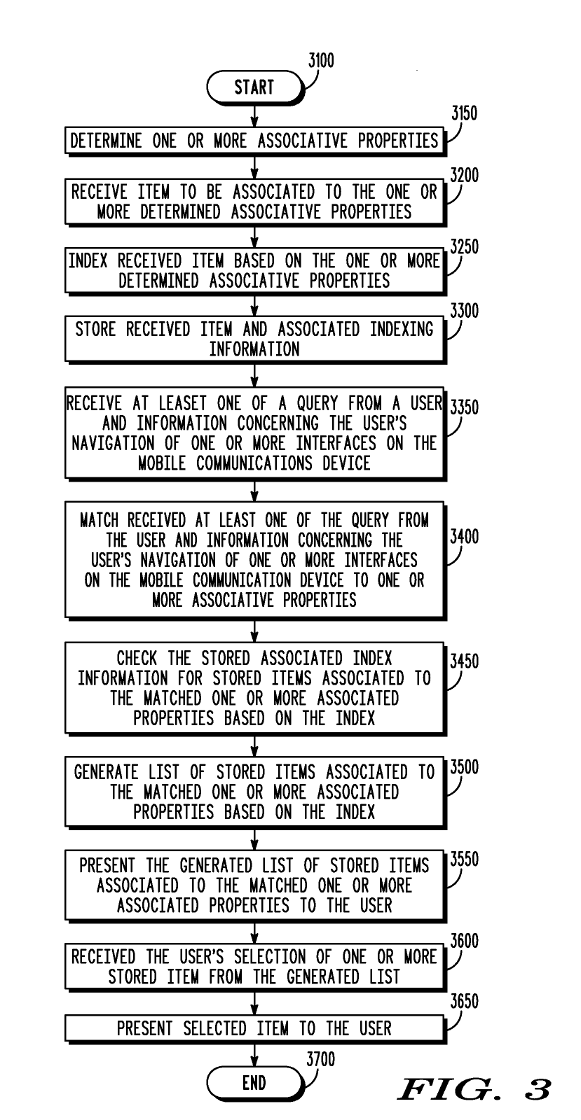

FIG. 3 is an exemplary flowchart illustrating some of the basic steps associated with information storage process in accordance with a possible embodiment of the disclosure. The process begins at step 3100 and continues to step 3150 where the associative personal information manager 280 may determine one or more associative properties. Note that the associative personal information manager 280 may associate items using similarity measurements based on at least one of time period of creation, location of creation, transmission recipient, title, annotation, access time period, access location, etc., for example.

At step 3200, the associative personal information manager 280 may receive an item to be associated to the one or more determined associative properties. The item may be at least one of a photo, a calendar entry, an address book entry, a contact entry, a voice recording, a video clip, a task, etc., for example.

At step 3250, the associative personal information manager 280 may index the received item based on the one or more determined associative properties. For example, the associative personal information manager 280 may index a stored item according to at least one of type of stored type, sender, creation time, creation location, time span, title, annotations, etc., for example.

At step 3300, the associative personal information manager 280 may store the received item and the associated indexing information in the personal information database 290. At step 3350, the associative personal information manager 280 may receive a query from a user and/or information concerning the user's navigation of one or more interfaces on the mobile communication device. The query may include a date, time, an event, a person, an address, a location, etc. The associative personal information manager 280 may receive information regarding certain navigation behavior through the various interfaces on the mobile communication device 100. At step 3400, the associative personal information manager 280 may match either the query from the user or the information concerning the user's navigation of one or more interfaces on the mobile communication device to one or more associative properties.

At step 3450, the associative personal information manager 280 may check the associated indexing information for stored items associated to the matched one or more associated properties. At step 3500, the associative personal information manager 280 may generate a list of stored items associated to the matched one or more associated properties based on the associated indexing information. For example, if a user queried “Megan's Party” then event information, photos, voice recordings, or other item associated with the event “Megan's Party” would appear on the generated list.

At step 3550, the associative personal information manager 280 may present the generated list of stored items associated to the matched one or more associated properties to the user. At step 3600, the associative personal information manager 280 may receives the user's selection of one or more stored item from the generated list. At step 3650, the associative personal information manager 280 may present the selected item (or group of items—such as group of photos) to the user. The process may then go to step 3700, and end.

The associative personal information manager 280 may also prompt the user to enter in additional information concerning the associative properties or the stored items, for example. The associative personal information manager 280 may then store any additional information entered by the user into the personal information database 290.

The associative personal information manager 280 may track the location of the mobile communication device using GPS, for example upon at least one of an item creation event, an item access event and an item usage event. In this manner, a list of items may be retrieved based on a location query, possible narrowed by date/time.

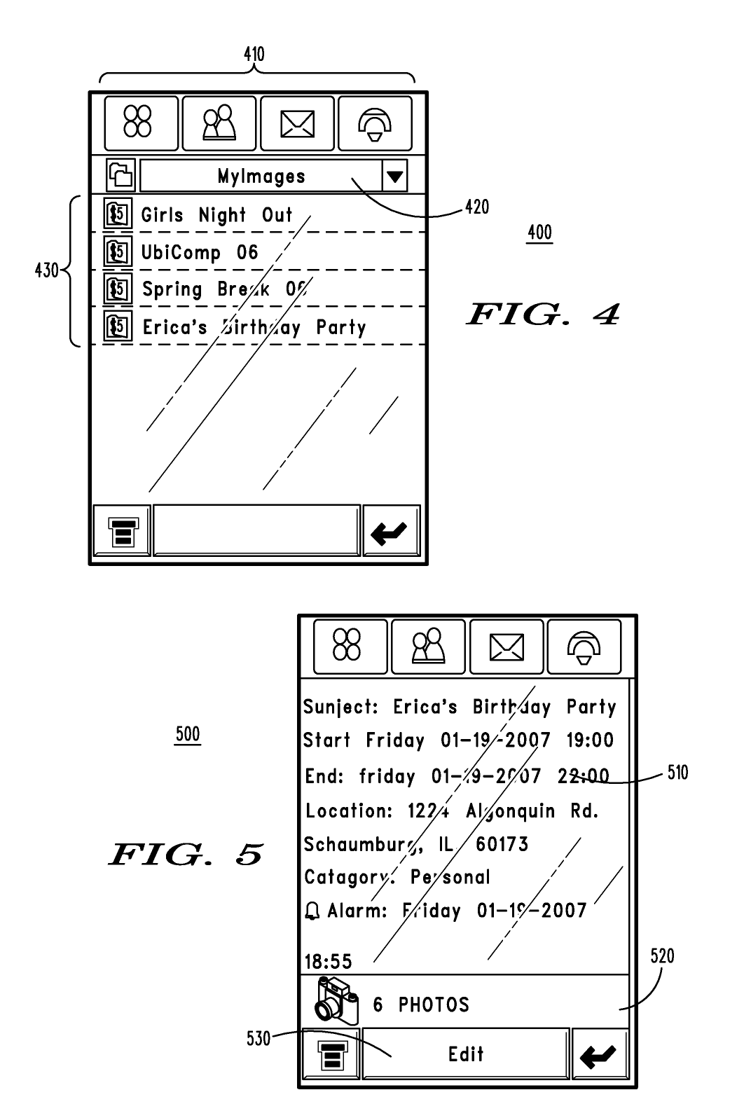

FIG. 4 is a screen shot 400 of an exemplary associative personal information management interface in accordance with a possible embodiment of the disclosure. The screen shot 400 shows an exemplary presentation to the user that may include one or more user interface buttons 410, a selected personal information category of stored items 420, and one or more stored items (or groups of stored items) 430 within the selected personal information category 420. The user interface buttons 410 may any buttons hard or soft that may help the user navigate through the mobile communication device 100, select stored items, and perform other tasks, such as edit, select, delete, annotate, associate, purge, etc. The screen may be an LCD display, a touchscreen display, or any other type of display that may be found on a mobile communication device 100.

The associative personal information manager 280 may use the in various scenarios to enhance the interaction experience for the user. The associative personal information manager 280 may automatically organize the resources so the user can quickly navigate to the desired item. For example, in taking photos during time spans corresponding to calendar events, a user may navigate to the photo viewer would see a screen as in FIG. 4.

In this case, the names of the photo collections may not have been generated by explicit user manipulation or tagging, but rather by “Created during” associations between the photos and the events. The associative personal information manager 280 may automatically group the photos under the associated event titles so the user can find them easier than wading through hundreds of images, most of the time with no more meaningful name than file names such as “MRPMAP9596.JPG”.

FIG. 5 is another screen shot 500 of an exemplary associative personal information management interface in accordance with a possible embodiment of the disclosure. The user interface buttons 410 may be the same, for example. The screen shot 500 shows an exemplary presentation to the user of an event 510, a link to photos 520 associated with the event, and an edit button 530, to edit portions of the event, photos, or association information.

The other thing the associative personal information manager 280 may do in the deterministic case is automatically provide navigation capabilities to related items. In the example in FIG. 5, a user has retrieved the details of a calendar event. The associative personal information manager 280 may queried the associated items and automatically created the “Photos” link at the bottom of the screen based on the results provided by the association service. Note that the user did not have to edit this event or tag the pictures explicitly to enable this behavior.

Embodiments within the scope of the present disclosure may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments of the disclosure are part of the scope of this disclosure. For example, the principles of the disclosure may be applied to each individual user where each user may individually deploy such a system. This enables each user to utilize the benefits of the disclosure even if any one of the large number of possible applications do not need the functionality described herein. In other words, there may be multiple instances of the associative personal information manager 280 each processing the content in various possible ways. It does not necessarily need to be one system used by all end users. Accordingly, the appended claims and their legal equivalents should only define the disclosure, rather than any specific examples given.

We claim:

1. A method for managing associative personal information on a mobile communication device, comprising:
determining one or more associative properties;
receiving an item to be associated to the one or more determined associative properties;
indexing the received item based on the one or more determined associative properties;
storing the received item and the associated indexing information;
receiving at least one of a query from a user and information concerning the user's navigation of one or more interfaces on the mobile communication device;
matching the at least one of the query from the user and information concerning the user's navigation of one or more interfaces on the mobile communication device to one or more associative properties;
checking the associated indexing information for stored items associated to the matched one or more associated properties;
generating a list of stored items associated to the matched one or more associated properties based on the associated indexing information;
presenting the generated list of stored items associated to the matched one or more associated properties to the user;
receiving the user's selection of one or more stored item from the generated list; and
presenting the selected item to the user.

2. The method of claim 1, further comprising:
prompting the user to enter in additional information concerning one of the associative properties and the stored items; and
storing the information entered by the user.

3. The method of claim 1, wherein the stored item is at least one of a photo, a calendar entry, an address book entry, a contact entry, a voice recording, a video clip, and a task.

4. The method of claim 1, wherein a stored item is indexed according to at least one of type of stored type, sender, creation time, creation location, time span, title, and annotations.

5. The method of claim 1, wherein stored items are associated using similarity measurements based on at least one of time period of creation, location of creation, transmission recipient, title, annotation, access time period, and access location.

6. The method of claim 1, further comprising:
tracking the location of the mobile communication device upon at least one of an item creation event, an item access event and an item usage event.

7. The method of claim 1, wherein the mobile communication device is at least one of a portable MP3 player, a satellite radio receiver, an AM/FM radio receiver, a satellite television, a portable music player, a portable computer, a wireless radio, a wireless telephone, a portable digital video recorder, a cellular telephone, a mobile telephone, and a personal digital assistant.

8. An apparatus that manages associative personal information on a mobile communication device, comprising:
a personal information database; and
an associative personal information manager that determines one or more associative properties, receives an item to be associated to the one or more determined associative properties, indexes the received item based on the one or more determined associative properties, stores the received item and the associated indexing information in the personal information database, receives at least one of a query from a user and information concerning the user's navigation of one or more interfaces on the mobile communication device, matches the at least one of the query from the user and information concerning the user's navigation of one or more interfaces on the mobile communication device to one or more associative properties, checks the associated indexing information for stored items associated to the matched one or more associated properties, generates a list of stored items associated to the matched one or more associated properties based on the associated indexing information, presents the generated list of stored items associated to the matched one or more associated properties to the user, receives the user's selection of one or more stored item from the generated list, and presents the selected item to the user.

9. The apparatus of claim 8, wherein the associative personal information manager prompts the user to enter in additional information concerning one of the associative properties and the stored items, and stores the information entered by the user.

10. The apparatus of claim 8, wherein the stored item is at least one of a photo, a calendar entry, an address book entry, a contact entry, a voice recording, a video clip, and a task.

11. The apparatus of claim 8, wherein the associative personal information manager indexes a stored item according to at least one of type of stored type, sender, creation time, creation location, time span, title, and annotations.

12. The apparatus of claim 8, wherein the associative personal information manager associates stored items using similarity measurements based on at least one of time period of creation, location of creation, transmission recipient, title, annotation, access time period, and access location.

13. The apparatus of claim 8, wherein the associative personal information manager tracks the location of the mobile communication device upon at least one of an item creation event, an item access event and an item usage event.

14. The apparatus of claim 8, wherein the mobile communication device is at least one of a portable MP3 player, a satellite radio receiver, an AM/FM radio receiver, a satellite television, a portable music player, a portable computer, a wireless radio, a wireless telephone, a portable digital video recorder, a cellular telephone, a mobile telephone, and a personal digital assistant.

15. A mobile communication device, comprising:
a personal information database; and
an associative personal information manager that determines one or more associative properties, receives an item to be associated to the one or more determined associative properties, indexes the received item based on the one or more determined associative properties, stores the received item and the associated indexing information in the personal information database, receives at least one of a query from a user and information concerning the user's navigation of one or more interfaces on the mobile communication device, matches the at least one of the query from the user and information concerning the user's navigation of one or more interfaces on the mobile communication device to one or more associative properties, checks the associated indexing information for stored items associated to the matched one or more associated properties, generates a list of stored items associated to the matched one or more associated properties based on the associated indexing information, presents the generated list of stored items associated to the matched one or more associated properties to the user, receives the user's selection of one or more stored item from the generated list, and presents the selected item to the user.

16. The mobile communication device of claim 15, wherein the associative personal information manager prompts the user to enter in additional information concerning one of the associative properties and the stored items, and stores the information entered by the user.

17. The mobile communication device of claim 15, wherein the stored item is at least one of a photo, a calendar entry, an address book entry, a contact entry, a voice recording, a video clip, and a task.

18. The mobile communication device of claim 15, wherein the associative personal information manager indexes a stored item according to at least one of type of stored type, sender, creation time, creation location, time span, title, and annotations.

19. The mobile communication device of claim 15, wherein the associative personal information manager associates stored items using similarity measurements based on at least one of time period of creation, location of creation, transmission recipient, title, annotation, access time period, and access location.

20. The mobile communication device of claim 15, wherein the associative personal information manager tracks a location of the mobile communication device upon at least one of an item creation event, an item access event and an item usage event.

21. The mobile communication device of claim 15, wherein the mobile communication device is at least one of a portable MP3 player, a satellite radio receiver, an AM/FM radio receiver, a satellite television, a portable music player, a portable computer, a wireless radio, a wireless telephone, a portable digital video recorder, a cellular telephone, a mobile telephone, and a personal digital assistant.
